(19) United States
(12) Patent Application Publication
(10) Pub. No.: US 2020/0299585 A1
(43) Pub. Date: Sep. 24, 2020

(54) OSWALD SYSTEM

(71) Applicant: Precision Energy Services, Inc., Hayden, ID (US)

(72) Inventors: Michael Oswald, Hayden, ID (US); Anne Schwartz, Hayden, ID (US)

(73) Assignee: Precision Energy Services, Inc., Hayden, ID (US)

(21) Appl. No.: 16/894,538

(22) Filed: Jun. 5, 2020

Related U.S. Application Data
(62) Division of application No. 15/998,244, filed on Jun. 5, 2018, now abandoned.
(60) Provisional application No. 62/515,380, filed on Jun. 5, 2017.

(51) Int. Cl. C10B 47/24; A62D 3/33; G21F 9/12; C05D 9/00; C10B 57/06; C09D 17/00; A01N 43/40; A01N 43/36; A01N 37/10; C10B 53/02; B01J 20/20; A01N 61/00; C10B 49/10

(52) U.S. Cl. CPC C10B 47/24; A62D 3/33; G21F 9/12; C05D 9/00; C10B 57/06; C09D 17/003; A62D 2101/02; A01N 43/36; A01N 37/10; C10B 53/02; B01J 20/20; A01N 61/00; C10B 49/10; A01N 43/40

(57) ABSTRACT

A continuous bubbling fluid bed process converts biomass feedstocks into energy/heat, engineered biochar particles (including nanoparticles) and a vapor stream of organic compounds. The products have a multitude of applications determined by the specific conditions at which the process was operated, specifically controlling: temperature, catalysts, residence time, element and compound concentrations, and withdraw of products from various points in the system. The introduction of air, steam, and various gases into the vessel at selected locations and at controlled rates enables the economic, dependable and consistent production of these products.

This application is a divisional of U.S. application Ser. No. 15/998,244, filed Jun. 5, 2018, which claims the benefit of 62/515,380 filed Jun. 5, 2017, which are incorporated herein by reference, in their entirety, for any purpose.

### TECHNICAL FIELD

The disclosure herein relates to methods, processes and systems for converting renewable biomass into energy, biochar, volatile organic compounds, carbon, and/or ash based products.

### BACKGROUND OF THE INVENTION

Biochar is present in soil and has been produced since the occurrence of fire. Biochar is the residual from burned cellulose or other waste materials. Interest in biochar has come from the fact it is a stable material and does not release CO2 into the atmosphere, unlike decaying vegetation such as wood. Carbon is very inert and would take several thousand year to decompose. Therefore biochar could dramatically reduce CO2 emissions.

Cellulosic biomass can be directly burned to provide thermal energy. This method has been used for thousands of years to produce heat/energy. However direct combustion is considered unsuitable and inefficient for energy applications, so modern techniques using gasification systems have emerged. The majority of these systems utilize fossil fuel and release greenhouse gasses. A problem with gasification is high toxic NOx, COx emissions and tar.

Production of biochar is considered a negative by inventors of the art, and methods to more completely combust carbon are taught to decrease or eliminate char production. Overall fluidized bed gasification of biomass has been hampered from problems related to ash and tar. Sintering occurs as alkali metals react with silica by breaking Si—O—Si bonds to form silicates and sulfates. These substances melt and are deposited on walls causing corrosion and erosion. This happens around approx. 1,250° F. or higher. Injection of air or oxygen is required by these systems to keep the heat high enough to reduce emissions. Additionally high tar production from renewable biomass gasification fouls gas turbines. This creates a problem since by cooling or decreasing the temperature to eliminate sintering, you would increase emissions of these older systems. Furthermore traditional gasification systems cannot easily adapt to multiple types of feed stocks, such as those containing organic and inorganic materials. Inorganic constituents of feedstocks can result in less than complete combustion of the organic portion and therefore decrease energy production. This may result in highly concentrated ash, in a more soluble form, with a higher risk of leaching into the environment. The amount of ash accumulation for a typical energy plant adds up to thousands of tons a year and is around 5 percent of Green Dry Tons (GDT). Annually 200,000,000 to 260,000,000 Green Dry Tons of fuel are required to operate a 10 MW/hr electricity producing plant, yielding approximately 10,000 to 13,000 tons of ash for current systems.

Lastly a technique has been developed to destroy hazardous organic waste streams using steam reforming systems, as taught by U.S. Pat. No. 4,974,587 to Terry R. Galloway. The entire contents of the patent are incorporated herein by reference. The drawback of this system is that it has two separate reaction zones requiring heat which is externally supplied by two U-shaped hairpin loops of electrical resistance heating elements in the second reaction zone. The energy consumed to produce the clean gas results in a decrease in net profitability of the system.

### PRIOR ART

The system from U.S. Pat. No. 4,075,953 Low Pollution of Solid Waste to Norm Sowards describes a pollution free combustion system and fluidized bed. The entire contents of this expired patent are incorporated herein by reference. The aspects of the invention claimed are a novel incinerating or pyrolysis system using a unique vortex generator system with or without vertical stagnation columns to increase residence time of solid waste materials in a vapor zone above a fluidized bed in a vessel thereby accommodating full combustion and preventing loss of fine particles from the fluidized bed. Another primary objective is a novel air-jet fuel injection system for the use of solid waste incineration. Another primary objective is the provision of a unique system for isolating and removal of tramped material during incineration. Further the bed is comprised of olivine. This prior art invention disclosure does not mention biomass as a fuel, gasification nor custom production of chemically engineered biochar. The method being proposed for patenting in this application does not include a vortex generator.

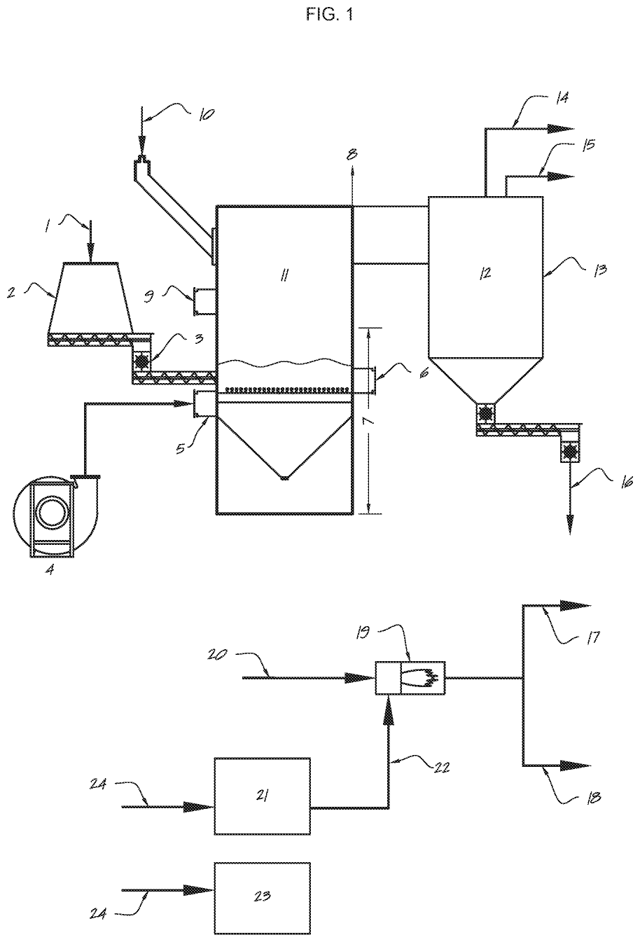

### BRIEF DESCRIPTION OF THE SYSTEM AND FIG. 1

### The Oswald Low BTU Pyrolysis Switching Gasification System

This system is composed of the following and is in reference to FIG. 1, which, in its entirety refers to a “Computerized Pyrolysis Switching Gasification System” (various configurations of parts are optional, and system components depend on main products chosen for production): FIG. 1:
1) Optical cable with cameras attached horizontally over a conveyer, interfaced with a computerized algorithm and library of composition tables for control of system to adjust to changing fuel moisture, density and amount of dirt or non-biomass material and system inputs needed.
2) Fuel Bin, for preprocessing a nebulized spray of chemicals or water is added evenly over the fuel inside the bin, prior to entering fluidized bed. wherein fuel is moved into the fluidized bed by #3.
3) Metering Screw with Fuel Feed controlled by a Computerized Control System Equipped with Lookup Library, Fuel and Product Settings.
4) FBG Fan
5) Fluidized Bed Air Inlet—allows deposition of gas or other chemicals over the bed.
6) Biochar Bed Level Removal System—Weir with controlled opening, over or adjacent to bed with sliding timed door.
7) Bubbling Fluidized Bed with proprietary ratios of bed material and unique shaped design for bed cleaning and cooling.
8) System Wall Height is unique and controls amount of time and heat are received before products can fly out of chamber. This also controls particle size.
9) Gasification Inlet—The sensor controlled system contains Inlets to add gasses into the bed.
10) Processer Fuel Over Bed for addition of processed carbon to be redeposited over the Fluidized Bed
11) FBG Gasification Section
12) Cyclone
13) Corn Sonicator for Ash and carbon removal from
14) Low BTU Gas Extraction
15) Electromagnetic Particle Removal
16) Ash and Carbon Sorting and Removal
17) Dryer System
18) Boiler/TG System
19) Carbon and LBG Burner
20) Low LBU Gas
21) Ash and Carbon Particle Separator
22) Reaction Chamber
23) BIOCHAR REACTION CHAMBER
24) ASH/CARBON111

Testing of system inputs, products and substrates by multiple sensors and mechanical controls are needed for flexibility and control of the system. System controls are employed to operate the system, and are guided by calculated algorithm, and stoichiometric ratios based on in-put and sensor data. Features of the system allow for temperatures, gas/air, fuel feed speed, and chemicals added to be optimize for efficiency of production of energy and products. It also allows specific control of product structure and composition.

The system combines these components in a proprietary fashion for a unique purpose of controlling structural and chemical properties of biochar produced and energy production efficiency.

### System Components, Equipment and Processing

### The Oswald System Low BTU Pyrolysis Switching Gasification System

### A1) System Produces Electricity, Biochar and Char Micro and Nano Particles

In order for biomass renewable energy and renewable micro and nanomaterial manufacturing facilities, to reach a level of production that is profitable and sustainable. It is important that they are designed to be scalable and can keep costs down by being able to use forest slash piles or other dirty waste for fuel. This helps to ensure a less expensive and ample fuel supply. Unlike other systems this system can handle waste and dirt and does not result in significant highly concentrated ash or sintering and yet fosters low emissions and little formation of tar. This system addresses the need to produce a low emission (low NOx, COx) gasification system. It accomplishes this by enabling the burner to produce high energy at lower temperatures through a high efficiency combustion process, with minimal waste products, especially of NOx and COx. Temperatures of the system stay below 2,000° F. or steam reforming is used to control emissions.

Current systems lack components or design that enable flexibility for production of multiple products rendering them inefficient, un-scalable or unreliable and inflexible to respond to changing fuel resources and product markets. This results in unprofitable and unsustainable enterprises. This invention illustrates a new sustainable and flexible method of producing energy, engineered biochar, micro and nano products. It additionally address methods to produce new products to provide solutions to agricultural, environmental and biological problems.

This invention addresses the need for commercial scale ability to produce specifically engineered biochar through mechanical, chemical, IR sensing, time and temperature controls, machine learning and computational algorithms and pre and post treatments of system inputs and products. This information has been uniquely assimilated from discovery that resulted from years of testing and experience.

B1) Electricity Is Produced From: Pyrolysis/Combustion/Gasification from Biomass Waste and Potentially Stored Liquid or Biochar Fuel.

C1) Pyrolysis Switching Combustion and Gasification System for Production of Biochar Products (Using Pre, Post and in Process Processing)

The Oswald System runs from pyrolysis to gasification temperatures between 830 to 2600 deg. ° F. Sensors facilitate this by: 1) measuring the exact amount of fuel and dirt, and the ratio of moisture which enables the accurate adjustment of the rate at which fuel is metered in to the bin for best efficiency of products being produced, 2) computational, sensing ability and mechanical parts assembly such thermocouples, fuel feed screw, recirculating air heater, forced draft fan, gas injectors, enable quick alteration of the temperature for formation of products, 3) design enabling control of recycled fuel gas and addition or restriction of other gasses (I.e. O2 can be restricted or added based on the need and percent of products desired, i.e. energy, biochar), 4) the system can be sized to produce gas in excess of energy needs, which can be pulled off for other product synthesis such as citric acid, functionalized nano-particles or liquid fuel, 5) unique wall height of both the bed and gasification chamber allows more time and temperature for more complete combustion of materials. This reduces emissions and controls size and chemistry of products leaving the gasification chamber.

Unique production of products can be accomplished by: 1) temperature range of system (different products require different temperatures) gas percentages, 2) biochar collection accessible from over or adjacent to the bed and system for cooling and processing, 3) collection of biochar products after exiting the cyclone as char and systems for cooling and processing, 4) collection after passing the cyclone as gas then separated using an electrostatic method, 5) after extraction into a cooling/tempering reaction chamber gas can be reacted with FE3 or other chemicals, or catalysts to form nano materials. 6) bed material, addition and extraction is used to control catalytic, cation exchange, oxidative or reductive activity for specific engineering of biochar, micro and nano materials, 8) pretreatment of fuel or posttreatment of biochar.

The problem of sintering is prevented by fuel input being at floor height of bubbling bed and by keeping the temperature at less the 1210° F. or for higher temperatures the addition of magnesite and iron oxide in the bed prevents sintering. The bubbling fluidized bed enables fast high mass transfer of heat to biomass. Emissions of NOx and COx are controlled because temperature of biomass quickly reaches 1000-1200° F. and oxygen is deprived in a pressurized system and effectively reduces gas emissions. The system is unique in that it starts with combustion and is turned into gasification for fast conversion into Low BTU gas. Warming fuel first in a combustion chamber reduces the oxygen by increasing fuel consumption instead of reducing air. This is optimized by the computerized system that monitors heat and gas produced and adjust rate of fuel fed into the system. If higher temperatures are desired for production of specific biochar products gasses, moisture and chemical composition of materials in bed are adjusted to prevent sintering.

### Detailed Description of the Invention the “Oswald SYSTEM”

The current invention makes use of a variety of methods, equipment design and controls to provide a flexible system with the following attributes:

The gasification system works by gasifying mixed waste biomass (containing some soil from multiple sources) in a bubbling fluid bed under sub-stoichiometric conditions. Fuel is loaded into the fuel in bed then moisture and density are determined by an infrared FT device. This information is used to determine conditions needed for combustion, gasification and biochar optimization. Fuel is then metered into a fluidized bubbling bed. A bed of granular alumina and silica minerals at static depths of 20-24 inches cover a series of evenly distributed manifolds with nozzles to provide an even flow of air to the entire surface area of the circular vessel. The air forced through the nozzles will ‘fluidize’ the bed material, expanding the bed to an active height of 30-36 inches. The fluid bed and vapor space above the bed will be maintained at a temperature range between 850-2,800° F. from woody biomass fuel. The fuel is fed via a high-alloy feed tube into the center of the vessel from above. The reaction chamber height play a key role in the size of particles and mixture of gas leaving the gasification/pyrolysis chamber and is part of the innovation of the invention. The bed wall height is key to this invention because it allows a turbulent layer and a semi static layer with temperature differences between the two, allowing large rocks or soil to pass into the bed and sink to the bottom for removal at a reduced temperature. This method facilitates the use of biomass waste since it can process out the soil. The system also accommodates higher moisture content and mixed fuel through a combination of grinding the biomass and use of the bubbling bed to efficiently convert the biomass to gas.

The fuel is transformed into a Low BTU Gas (LBG), composed of CO, Hydrogen, and a mix of trace hydrocarbons and tars. The gasification chamber height is key in determining size of char particles and the reduction of emissions through more complete combustion and gasification. The system produces 5 to 10% of Bone Dry Tons (BDT) of fuel as char, micro and nano particles.

The LBG containing small particles of high carbon char which are carried out of the vapor space and separated via a cyclone. The remaining LBG is burned in an appropriately sized burner to handle the high-temperature LBG stream, which is installed in place of a standard grate combustion system that usually resides inside the boiler.

The char that comes from the gasification system is a mixture of carbon and ash, of which biochar can either be reinjected into the system as a fuel source or sold as a separate byproduct. These byproducts include biochar for soil amendment, water filtration carbon, or pelletized carbon used as a renewable drop-in-place coal substitute etc. Char nano and micro materials are also formed depending on the ratio of compounds in bed or pretreatment of fuel.

### Flexibility of the System

The combination of components of the system, the wide range of temperatures it can be run at (415° C. to 1400° C.), and the fact it can run under pressure, with or without high O2, give this system unparalleled flexibility and is part of the patent. The system therefore can be operated at different conditions to produce custom biochar with various attributes. This is needed for an economically viable biochar system since there are many markets for biochar and different biochar specification are needed for different applications. For a company to be competitive they must supply a reliable and high quality biochar chemically and physically optimized for each market application.

The present invention describes a reinjection system for biochar which enables use of biochar when fuel is scarce. During winter months when the plant is running off of stored biomass PES can pulverize and reinject the biochar to burn it for fuel. The reinjection system will carry the char from the cyclone to a ball grinder which is then it is blown into the LBG burners allowing the Oswald System to use biochar as fuel and complete combustion to energy.

All of the following iterations of described biochars can be functionally tuned by char porosity, particle size, functional groups and chemical composition. The Oswald System is unique in its ability to use its energy systems functional parts to produce/engineer, reliable percentages of char size, pore structure and functional groups and particle size desired. Additionally this patent puts forth the premise that identical surface groups on biochar can function differently in exactly the same conditions if the porosity of the char is different. Porosity refers to the size and number of pores in the char particle. It further put forward the particle size and mixture (percent use of different size particles in relation to one another) of particle sizes for any application will change the overall function of the system.

C2) A Pyro-gasifying Rotary Kiln is used to produce energy and biochar by being equipped with the components and conformed to the controls used in the preceding discussion. Additionally gas produced by the modified rotary kiln is used to either power a boiler or is further processed to liquid fuel, other chemicals and or nanoparticles.

A2) Gas stream: LBG gas stream is reacted with various catalysts to create different types of nano materials such as magnetic iron containing nano spheres.

B2) Citric acid or other chemicals: Gasification for production of LBG gas

Low LBG gas can be produced in excess of Energy needs. This excess gas can be extracted after exiting the cyclone and processed into liquid fuel or chemicals in high demand such as citric acid. This reference is sighted to present a unique method of capture and the ability to engineer a high volume commercial system that can produce gas in excess of turbine requirements.

### A3) Biochar,

Problems this Invention Provides a Resolution for:

3) Biochar found from simple burning of wood or other materials such as grass has low numbers of exchangeable cations. Therefore there is a need to produce biochar with increased numbers of cation exchange groups. Biochar has recently been standardized for quality and is graded on percentage carbon and cation exchange capacity (CEC). A CEC of less than 50 mmol/kg is considered poor quality, a CEC above 50 mmol/kg but below 250 mmol/kg is considered medium quality and above 250 mmole/kg is considered high. However there are no other parameters other than CEC defined. This lack of definition for other potential benefits of biochar in part stems from lack of control in the production of biochar. There is a need for commercial scale production methods to specifically engineer biochar with high cation exchange activity.

Additionally there is a problem with nitrogen volatilization causing deposition of nitrogen on land and water from high manure residues. In Georgia alone 2.1 Million Mega grams of poultry liter is produced per year. Nitrogen in poultry litter volatilizes into air by up to 60% of nitrogen. Deposition of NH3 causes nitrogen loading of lakes, indirect soil acidification, low buffering capacity of soil due to nitrification and damage to sensitive crops like tomato, cucumber and conifers. Additionally P can run off and contaminate water through acidification of soil. Biochar absorbs P. Acidified biochar will reduce soil Ph therefore halt volatilization and loss of both N and P. It also acts to increase buffering in soil. Therefore there is a need for custom engineering of biochar Ph and chemical groups to address remediation of the soil and environment or for biomedical applications.

Another problem: is the lack of effective counter measures for radiation accidents where treatment is either needed to prevent exposure to people, or people have been exposed and ingested radioactive volatiles of cesium or iodine that needs to be removed from the intestines by a nontoxic absorbent to prevent absorption.

### Preliminary Results to Support the Current Approach

Preliminary testing was conducted to validate the approach of making nano and micro particles using a commercial combustion and gasification system. Additionally testing was conducted to validate the concept that nano and micro particles can inhibit acetylcholinesterase activity.

### Nano and Micro Particles:

Biochar micro and nano particles were generated from a commercial combustion and gasification system using a proprietary catalyst and three wood varieties (Pine Bark 50%, Hemlock 25% and Fir 25%) representative of fuel commonly used at the site. To analyse the size of the resulting particles a Nicom 380 Particle Sizing Systems, Inc. Santa Barbara, Calif., USA was used. The nano and micro particles were sonicated and separated into two samples and dispersed in DI water, then injected into the Nicom 380 system. Sample 1 was unfiltered. Sample 2 was filtered using a syringe 0.45 μm cellulose acetate filter to remove any larger particles or impurities. Sample 1 and 2 were analyzed using the following NICOMP scale parameters: Plot Size=45, Smoothing 3, Plot Range 100, Run Time 0 Hr 53 Min 16 Sec, Wavelength 632.8 nm, Count Rate 14 KHz, Temperature 23 deg C, Channel #1=16.5 K, Viscosity 0.933 cp, Channel Width 10.0 uSec, Index of Ref.=1.333 This resulted in overall results of Mean Diameter of 916.7 nm, S.Dev.=78.6 nm (8.6%) Vol=100.0% for sample 1, and for sample 2 Mean Diameter was 299.7 nm, Fit Error=9.634, Residual=78.024 Min.

Results for sample one indicated there was only one peak as reported above. We anticipate this was the case since smaller particles seem to agglomerate with larger ones so that further sonicating and filtering is required to separate them (10). Results for sample 2 indicated there were two peaks, one with a volume distribution mean of 11.2 nm (SD 0.7) represented less than 4% of total sample. The second peaks volume distribution mean was 312nm (SD 37.3) and represented 96% of the sample. Results also indicated there was some agglomerating of particles. Nano particle yields could potentially be increased by dispersing them in a buffer prior to a second sonication step, or using different composition or percentage of catalyst (20). Results indicate micro and nano particle production is possible. This project will determine methods to efficiently produce nano particles below 100 nm and micro particles below 450 nm. Additionally we will explore methods to increase yields.

### Enzyme Inhibition:

Acetylcholinesterase (AChE) is a membrane-bound enzyme responsible for the degradation of acetylcholine (ACh). Acetylcholine is involved in nerve impulse. If ACh is not hydrolysed by AChE then nerve impulses cannot be shut off resulting in damage to nerves and organs. In the heart this could cause tachycardia and death. Toxicity to insects from organophosphate pesticides like chlorpyrifos is cause by pesticide inhibition of AChE. To demonstrate biochar micro and nano particles could provide a means to inhibit or kill insects but not harm People we used an AP AChE activity assay kit MAK119-1k and AP AChE type v-s from electric eel c2888 bo from Sigma-Aldrich (20-33). This targets only insect AChE. Seventy UL-850 UL UV Micro Cuvettes were used and analyzed with a Hach 4000 Spectrophotometer at the 412 nm wave length. Two replicates each of 20 μL and 30 μL of biochar particles in DI water from sample 2 were tested with AP AChE as compared to AP AChE alone with reagent. The experiment was conducted in accordance with the test protocols. Ten μL of AP AChE was used in each test with 190 μL of reagent at pH 7.5. In accordance to the literature (27-29) a real zero was calculated using 30 μL of biochar particles and 190 μL of reagent as a control. Test results indicated biochar did inhibit AP AChE activity. There were slight time variations of the test which are evident in FIG. 3 and Table 1. However; despite these variations test results indicate this approach has validity. This phase 1 SBIR project will allow us to determine differences in inhibition of AChE by particle size and percent functional groups. The identification of particle size and functional groups that specifically targets harmful insects, while not proving toxic to animals, humans, and beneficial insects, will greatly enable this project to contribute to knowledge in the field and to provide feasibility of the concept. This understanding will allow development of methods to demonstrate an environmental friendly substitute for chlorpyrifos made from biochar nano and or micro particles to control insects.

This system provides a product to address the lack of effective counter measures for radiation accidents where treatment is either needed to prevent exposure to people, or people have been exposed to and ingested radioactive volatiles of cesium or iodine. This system product enables removal of radioactive volatiles by use of an applied or ingested nontoxic absorbent to prevent metabolic absorption.

B3) Production of biochar and derived nano or micro materials from: fluidized bed gasification or gyro-gasifying rotary kiln.

### Invention Controls for Specific Engineering of Biochar:

For more complete understanding of the production of custom biochar with the following characteristics: 1) high CEC, 2) cholinesterase activity 3) other enzyme activity such as inhibition, hydrolysis, or small molecule interacting biochar, 4) carbon nano particles formation and extraction, 5) specialized poly aromatic carbon sheets coalesced to form >60 to 80% carbon material, useful for chemical reformation and hydrogen extraction or other purpose, 6) biochar, micro and nano particles composed of sulfur, carbon, hydrogen and oxygen to form non-metal acid catalysts, 7).

In one iteration for −0.01 to −5 particles sizes a (BDW) volume over a density table is used for clean fuel and populated in a data base by biomass species, a lookup command and equation is then used to derive weight of soil and fuel in bin by comparing infrared measurement of actual fuel, moisture and density/volume—to compare with data look-up measures for types of wood and bark. This data is then computed using stoichiometric calculations in conjunction with wood species lookups for C, O, N and H % in raw biomass to calculate feed speed, and temperature needed to yield ratios of energy and biochar needed. Hydrogen, oxygen and temperature sensors in the fluidized bed allow the system to calculate any changes needed for fuel speed, oxygen, or hydrogen needed to optimize LBC gas and (C/O+N) ratio where the ratio is three or less for the finished biochar product in one example. The basic equation for pine bark that can be specifically modeled through the following gasification equations as one example are: Set of all atoms=(Ar, C, H, O, N, S, CL,). No metals are included as they will become components of ash and biochar.

The set of all species S present in the gasifier is estimated a follows:
S═Ar, C₍₃₎, CH₄, CO, COS, CO₂, C₂H₄, C₂H₂, C₂H₆, C₅H₈O₄, C₆H₁₀O₅, C₁₅H₁₄O₄, C₂₀H₂₂O₁₀, C₂₂H₂₈O₉, HCN, HCL, H₂, H₂O, H₂S, NH₃, NO, N₂

Each species present in vapor state, Exceptions: biomass monomers and biochar.
Compounds within the set are:
C(s): Char
C₅H₈,O₄: Hemicellulose
C₆H₁₀O₅: Cellulose
C₁₅H₁₄,O₄: Lig-C
C₂₀H₂₂O₁₀: Lig-O
C₂₂H₂₈O₉: Lig-H

The following equation illustrate this in one example relationship in which high cation exchange activity is controlled through a ratio as follows: Fuel (C₍ₛ₎, H₍ₛ₎, O₍ₛ₎, N₍ₛ₎)+H₂O (moisture+gas/air (% O₍ₛ₎, N₍ₛ₎, H₍ₛ₎)+(temperature+Pressure)×time=C₍ₛ₎, H₍ₛ₎, O₍ₛ₎ of biochar+Low BTU gasses+ash. In one example the ratio of carbon to oxygen is less than 2 for biochar. In other scenarios the ratios of chemicals, metals or salts are incorporated into the bed at specific ratios to catalyze formation of specialized nano materials or biochar or oxidize on planar surfaces of biochar.

The custom fluidized bed is unique in that it can be used to control the formation of biochar chemical composition. This is accomplished by mixing the biochar using air currents, to uniformly tumble them in the static portion of the bed, to increase or decrease the rate and height (from 0.01 to 3 feet) it is blown to. This causes uniform aeration and exposure of the char to controlled amount and type of gasses, resulting in the addition of chemical groups to biochar such as oxygen to create structure of char desired. Temperature is one method used for controlling char particle size, structure and Ph. Feedstock piece size and species also regulate biochar Ph and particle size and structure. Pretreatment in the fuel bin is considered a method of altering species composition prior to entry into the fluidized bed.

A computerized system with a settings algorithm based on chemical composition, moisture and density of the biomass is used to adjust system conditions to optimize energy production and biochar characteristics. This system also monitors temperature and gas produced as part of the quality control system.

A bubbling fluidized bed that allows sand and other components to cool before being dislodged which results in a continuous cleaning of the bed while the system is operating.

The system is able to automatically compute and add metals and or other chemicals or gas to optimize production of biochar materials, while at the same time maintain emissions free energy production. This increases quality of carbon materials produced, so that they meet the grade for use as macro, micro or nano particles for electronic, industrial, agricultural and medical market applications.

A biochar particle size sorter, ball grinder, particle size sensor and reinjection system are parts used for various biochar products. To use biochar as a fuel it is ground with the ball grinder and then reinjected into the boiler burner.

### A4) Micro Materials, A5) Nano Materials

In one example of the invention, nano particles are formed from bed catalysts reacting with the biomass in the gasification chamber and fluidized bed. Depending on the properties desired, biochar laden with nanomaterials, formed on the face of the biochar, can be captured at the bed height or after it exits the gasification chamber or cyclone. This char is then air tumbled and sonicated. Next, nano particles are collected on charged metal ribbons of a bag house, larger particles are removed using gravity flow, nano particles are removed from charge discharge and or corn sonicated; or char is reacted with 3% hydrogen peroxide and extracted by pressurized flow through a series of filters for collection of different size char particles.

### B4) Pre, Post and in Process Treatments:

Temperature, moisture, gas, catalyst, feedstock, mechanical and electrical systems

### This Inventions Carbon Product Use and Mechanism

### EXAMPLES 1: FOR SYSTEM OF ENGINEERING SPECIFIC CHEMISTRY OF PARTICLES BY SIZE TO CREATE NEW DELIVERY SYSTEMS

1) This system uses measurements of farmers' soil needs for nutrient retention, Ph and water conservation to calculate particle sizes and chemical composition of biochar needed by depth of soil. A computer controlled device filled with various streams of different sized char particles, loaded with fertilizer are blown in to furrows at correct depth needed. Seeds are then deposited with particles on top and covered with soil as farmer drives over the field. Self-layering in soil is important and a unique feature since particle size regulates flow and rate of flow through soil (i.e. self-layering of different size carbon particles deposited at different depths for delivery of nutrients as plants mature, providing release of fertilizer by plant maturity need, or to bind root extrudates to prevent attraction of pathogenic fungi or bacteria.

2) Different functional groups can be given to different layers for specific activity by layer or depth for self-assembly or to provide (i.e. specific nitrogen release systems by depth of soil. This would result from both depth design and biochar design to provide a beneficial growing media for bacteria that convert ammonia for nitrogen use by plants and functional groups of the design would provide absorption of excess nitrogen and release when osmotic pressure was lower) system attributes.

3) Varying sizes can be used to form functional matrices or material, (i.e. ability of a matrix to restrict, absorb or kill specific fungi in a soil at various depths using biochar engineered with sulfur groups).

### EXAMPLES 2 OF CHARACTERISTICS OF ENGINEERED POROSITY USING THE INVENTION

1) Higher energy state inside pores for binding reactions (i.e. Iodine absorption and holding)

2) Higher surface area for interactions (i.e. capacity to function over longer time periods due to increase pores)

3) Affects flow and overall charge to increase or decrease diffusion to the surface of the char (i.e. overcomes repelling forces to decrease diffusion time so product does not interact with other substances before diffusing to surface).

4) Directional flow created.

### EXAMPLES 3 OF USE AND MANUFACTURE OF ENGINEERED SUPRA MOLECULAR SYSTEMS FROM RENEWABLE BIOMASS OR WASTE MATERIAL

In an applied example of the system a supramolecular carbon based system is produced from renewable biomass or waste material using a pyrolysis, combustion or gasification system or any combination of these processes to produce an incomplete combustion of fuel, or a reformation and chelation of gasses, to form nano and micro particles. These particles can be used to form a carbon based supramolecular system and or molecular structure and or material. This system contains multiple examples all of which produce combinations of aromatic, aliphatic, heterocyclic, oxygenated products and side chains with a plurality of functionality depending on the molecular ratios and structure. Furthermore products produced can be chemically or mechanically altered to complete the manufacture of the supramolecular system. The system can be engineered to result in an aliphatic or aromatic structure having various iterations of active side chains and nonpolar regions. In addition the attachment to small graphene segments allow these supramolecular systems to easily dissolve in polymer solutions for various applications. Some advantages using chemical ring structures such as hexagonal carbon systems is they are stable and favor substitution reactions. This unique symmetry can provide a multitude of chemically active regions for specific macromolecule assembly. These systems can be used as they relate to a system effective to: 1) perhydrolysis (decontamination)of chemical warfare agents, 2) provide nitrogen or other nutrient or mineral stabilization and slow release in soils or as composting additive to prevent volatilization of nitrogen, 3) nano particle self-assembly for: biological, medical and drug application such as an organo-pesticide antidotes, amphiphiles, nano capsules, for gene and drug delivery, 4) industrial applications for smart clothing dye indicator of exposure, 5) antimicrobial, antifungal agent, bactericide, material or gel for treatment of wounds, 6) filter system for water, 7) soil remediation of heavy metals and pesticides or other toxins, 8) increase water holding capacity and regulation in soil, 9) can be engineered to perform as an enzyme.

### EXAMPLE 4 OF MATERIAL FOR DETOXIFICATION OF NEUROTOXINS

In another example of the system, a supramolecular system is constructed with a pocket containing a serine like structure including a carboxyl group and a hydroxyl group, a nitrogen, carbon-alcohol group, followed by nonpolar regions on each side. The primary mechanism of action for neurotoxins like Vx, Gp or organophosphorus (OP) insecticides, like chlorpyrifos and parathion, is to inhibit esterase like activity of the structure by their oxygenated metabolites (oxons), due to the phosphorylation of the serine like hydroxyl group located in the active site of the molecule. The rate of phosphorylation is described by the bimolecular inhibitory rate constant (ki), which has been used for quantification of OP inhibitory capacity. To document feasibility we have done preliminary testing with biochar carbon nano and micro chemically engineered particles. We have used the neuro toxin chlorpyrifos and tested biochar initiated breakdown of the toxin. The biochar can behave as an esterase enzyme or enzyme inhibitor of cholinesterase or other esterase's such as cellulase.

### EXAMPLE 5 BIOCHAR STRUCTURES FOR USE AS A PESTICIDE

In another example of the invention a nitrogen engineered biochar particle undergoes an electrophilic addition and then oxidation reduction creating a portion of the surface biochar that has varying structures such that a carbon ring is attached to so that C—NH2, is located between adjacent carbons in the ring, with a carboxylate group positioned attached to the adjacent carbon.

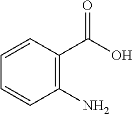

In another iteration a nitrogen biochar is engineered containing any of the following structures:

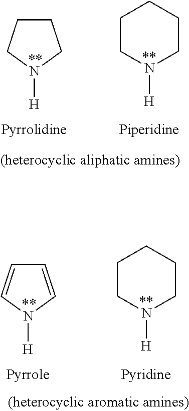 [SMILES: C1CCNC1 ; C1CCNCC1 ; c1cc[nH]c1 ; C1CCNCC1]

To any of these structures a plurality of halides such as CL are attached to 1, 2 or 3 of carbons on the carbon heterocyclic aliphatic or aromatic amine structure. In another iteration an EMP, phosphate or Phosphorothioate group is attached to a carbon in the ring between the nitrogen and the C—CL. Resulting in formation of R—R—O,O-diethyl-o-(3,5,6-trichloro-2-pyridyl)Phosphorothioate or R—O,O

In some iterations different halides or elements could be used including metal, organic or others.

In another iteration a benzene ring has a ketone formed on one carbon and an alcohol group on an adjacent carbon. In another iteration the six carbon structure has 1, 2, 3, 4, 5 or six alcohol groups attached. In yet another iteration one or multiple side chains can exist as ketone groups.

In one example the system produces the basic structure: O

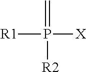

Where R1 and R2 are simple alkyl groups directly bonded to phosphorous or linked via S, O or N atoms. R1 and R2 are predominantly methoxy or ethoxy. The X group is a substituted or branched aliphatic, aromatic, heterocyclic, or alicyclic group with one or more carbon rings attached and with the active group linked to a phosphorous atom via a liable bond leaving group of O or S as depicted in the example. This type of chemical structure is important for activation or detoxification reactions for esterase inhibition and in neuronal receptor inhibition.

Unlike known actions of such structures as chlorpyrifos, one example of these structure could be too large to conform to enzymes, so enzymes or other reacting chemicals would attach to them.

### EXAMPLE 6 BIOCHAR AND ASH AS A REFLECTIVE, OR ABSORPTIVE MATERIAL OF PHOTONS

Biochar or ash particles can be engineered to produce isomers of any produced biochar surface structure. This would lead to unique material development such as photon scattering or absorptive material. In a specific iteration mu-metal, silver, lead, cadmium, platinum, palladium, titanium, nickel, copper, iron, gold, iridium or mixtures thereof are attached or formed as part of the carbon metal structure or oxidized product of combustion under specific conditions, and for example increase reflectance as iridium content is increased. In another iteration of the invention micro or nano particles of char containing oxidized or non-oxidized metals become self-layering based on hydrophobicity of materials then are dehydrated under heating or vacuum conditions to form a layered thin material. This material could have self-sacrificing or stabilizing properties such as the presence of oxides to prevent corrosion of metals or electrical circuits in a moisture environment.

### EXAMPLE 7 BIOCHAR AS AN ABSORBENT AND STORAGE MATERIAL FOR RADIOACTIVE WASTE IN PARTICULAR RADIOACTIVE IODINE

Background: Nuclear waste remains a serious problem for society. To date the Hanford site is a living testimony of the complexity and difficulty of storing nuclear waste. The health impacts from the site are far reaching and continued leaking of stored waste remains an unsolved problem. Recent studies indicate that cities with the highest concentration of surrounding nuclear plants have the highest rate of thyroid disease (U.S. Centers for Disease Control and Prevention, http://statecancerprofiles.cancer.gov.). From 1980 to 2006, annual U.S. thyroid cancer incidence rose nearly threefold, from 4.33 to 11.03 cases per 100,000 (age adjusted to the 2000 U.S. standard population). This increase has been steady, rising in 22 of 26 years, and has been most pronounced since the early 1990s (1). The expected annual number of newly diagnosed U.S. thyroid cancer cases has reached 37,340. More specifically, 11 of the 18 counties (population over 88,000) with the highest rates of thyroid cancer are clustered in a relatively small area of New Jersey, southern New York, and eastern Pennsylvania. This area, which encompasses a 90-mile radius, has 16 nuclear power reactors at seven plants, the greatest concentration of reactors in the U.S. (U.S. Centers for Disease Control and Prevention, http://statecancerprofiles.cancer.gov.) According to Evans, (Greg J. Evans et al, Modeling of iodine radiation chemistry in the presence of organic compounds, Radiation Physics and Chemistry 64 (2002) 203-213), in the event of a nuclear accident all fission products released contribute to the radiological dose; however the most significant releases are isotopes of radioactive iodine (123-135, 131 most prevalent) with the multiple species reacted in the accident. Prior to the development of nuclear plants iodine 127 a stable form, was the only iodine in existence. There are three main types of organic compounds of concern that react with iodine: carbonyls, aromatics, and alkyl halides. Carbonyl and aromatic compounds are released during an accident in significant amounts from paints, while alkyl halides are produced through the degradation of plastics or paints containing vinyl chloride. All of these species have a substantial impact on iodine volatility. After a nuclear accident the issue becomes containment of the waste products created in the accident. Leaching into soil and water provide a media for the possible continued volatilization and hydrolysis of radioactive iodine in the environment.

Two methods predominantly exist in which radiation or radioactive iodine species continue to escape into the environment are through water hydrolysis, decay and volatility. First radioactive iodine species are released into the soil through leaks in buried containment vessels and react with other organics or water. Evens et all stated, “The results indicated that organic compounds could be classified into groups, based on their distinct effects on iodine volatility. In the presence of carbonyls and alkyl chlorides, iodine volatilization increased significantly, up to two orders of magnitude. In the presence of aromatics the volatilization rate decreased at higher iodine concentrations and lower pH values, while it increased at lower iodine concentrations and higher Ph values. In the present system we have engineered aromatic carbon particles with a Ph value that is structured to absorb iodine and the nature of resonance in the complex structure enables stability of the molecule to hold radiation. Specifically nitrogen and or sulfur and or other halides or oxygen species are engineered into the aromatic carbon structure to create groups which will undergo nucleophilic substitution and aromatic nucleophilic substitution, addition and reduction reactions to form a covalent molecular iodine bond with carbon(s). This chemistry is achieved though reacting biochar particles with iodine in environmental, air, water, or biological systems. The biochar particles are engineered as previously described by the system and pre or post systems treatments.

### EXAMPLE 8 SYSTEM OF PRODUCING STRUCTURALLY ENGINEERED BIOCHAR WITH THE FOLLOWING CHARACTERISTICS: NUTRIENT AND BENEFICIAL BACTERIA STORAGE AND DELIVERY TO PLANTS AND INHIBITION OF ACETYLCHOLINESTERASE, POLYGALACTURONASES OR OTHER ESTERASES

The system has been used to engineer biochar particles with a specific chemical action and to identify and demonstrate the method and action of biochar particles to increase disease resistance of plants, inhibit or kill insects, fungi or harmful bacteria and promote plant and beneficial bacteria nutrient availability. The system utilizes a strategy of ratios of char particle size and functional groups to achieve this end.

In one example the mechanistic action of the product identified is inhibition of acetylcholinesterase and polygalacturonases by structurally engineered biochar and char-nanomaterial (between 0.5 and 450 nm).

The system further is to produce biochar particles with a chemical structure capable of binding acetylcholinesterase therefore inhibiting the enzymes ability to hydrolyze acetylcholine.

The physical and chemical structure of the engineered biochar enables nitrogen buffering and conversion of metal species to optimize chemical binding of char to acetylcholinesterase.

### Background and Brief Description of the Methods Involved

This invention iterates the system methods and production of custom biochar including nano-char and mechanism for specifically engineered char to inhibit acetylcholinesterase and polygalacturonase to prevent plant disease and maintain an optimal growing environment.

Plant pathogens use multiple methods to populate, invade and kill plants. This occurs from fungal, bacterial and insect pathogens in the rhizosphere surrounding the plant root. Interactions involving the roots include root-root, root-insect, and root microbe interactions. Plants extrude extradites and mediate a variety of interactions with beneficial as well as pathogenic organisms. Chemical response of root extradites may be positive negative or both. An example of this is the excretion of isoflavones by soybean roots attracting both Bradyrhizobium japonicum a mutualist and a pathogen Phytophthora sojae. Self-layering of different size carbon particles deposited at different depths for delivery of nutrients as the plant matures, can provide release of fertilizer by plant maturity need, or bind root extrudates caused from plant maturity growing cycle, that attract pathogenic bacteria to reduce disease. Engineered biochar can also act as a decoy for pathogenic bacteria and fungi by detection of chars engineered electrical charge caused by diffusion of nutrients or chemicals which they are drawn to. Once bound they would be killed by biochar particle engineered sulfur containing groups. Additionally specific engineered Ph and chemical groups of char particles could increase uptake by plant roots and cells to inhibit acetylcholinesterase produced by pathogens. Utilizing combinations of different sizes and different chemical structure in char particles; antifungal or antibacterial systems could be designed and tuned to function against variety of pathogens in various types of soil.

Another application is to engineer biochar particle chemical composition for various application such as “to inoculate biochar with various bacterial species to interact with the chemically engineered and physical functions of the biochar for a variety of specialized applications such as bacterial degradation and remediation of PCBs, benzene and perchlorate or other environmental toxins”. The improvements incorporated leverage benefits of the system design from raw ingredient to finished product. Specifications incorporated in the design innovatively remove barriers to use of biochar by improving ease of application and value added to end user.

### SUMMARY

### (A) Products Produced by the System:

A1) Electricity, A2) Chemicals from gas stream, A3) Biochar, A4) Micro Particles A5) Nano Particles such as a non-toxic pesticide; and methods for various applications of engineered and applied products herein.

### (B) Method of Producing it:

B1) Electricity: —from pyrolysis switching/combustion/gasification system or rotary kiln pyrogasifier, using biomass or waste and potentially stored liquid or char fuel

B2) Citric acid or other chemicals: from system processes to convert LBTU gas to products.

B3) Biochar and derived nano or micro materials from: fluidized bed gasification/combustion or rotary kiln pyrogasifier.

B4) Pre, post and in process treatments for biochar, micro and nano particles for specific products: Temperature, moisture, gas, catalyst, feedstock, mechanical and electrical systems

### (C) Physical Systems and Components Used to Produce Products:

C1) Pyrolysis switching combustion and or gasification system+pre, post and in process processing

C2) Rotary Kiln Pyrogasifier

What is claimed is:

1. A fuel input apparatus comprising:
an optical cable with cameras attached horizontally over a conveyor, the optical cable interfaced with a computerized algorithm and a library of composition tables to identify information comprising: moisture, species of wood, amount of wood, amount of non-wood and wood biomass, foreign objects, or combinations thereof, wherein the information is provided to an internal processing unit to allow adjustment of system controls for fuel feed rate, moisture, density, gas and catalyst or other chemicals needed;
a fuel bin configured to contain a nebulized spray of chemicals or water combined with the feedstock at the fuel bin, wherein the nebulized spray of chemicals or water is provided evenly over the fuel inside the bin;
a metering screw with a fuel feed controlled by a computerized control system equipped with a lookup library, fuel and product settings, wherein the metering screw is configured to move the nebulized spray of chemicals or water into a fluidized bed; and
a Forced Draft Fan (FDF) positioned at an input of the internal processing unit, wherein the FDF provides fluidizing air or gases into the internal processing unit.

2. The fuel input apparatus of claim 1, wherein the internal processing unit is configured to control internal processing conditions, the internal processing unit comprising:
a fluidized bed air inlet coupled to the FDF, wherein gases or other chemicals are configured to be deposited over the fluidized bed through the fluidized bed air inlet;
a biochar bed level removal system comprising a weir with a controlled opening, the biochar bed level removal system provided over or adjacent to the fluidized bed with a sliding timed door positioned there between;
a fluidized bed coupled to the fluidized bed air inlet on one side and coupled to the biochar bed level removal system on another side, the fluidized bed having a ratio of bed material;
a gasification section at a system wall height above the fluidized bed, wherein the gasification section defines a vapor space, wherein the system wall height determines an amount of time products remain in the vapor space before the products exit the vapor space and particle sizes of the products exiting the vapor space;
a gasification inlet coupled to the one side of the gasification section, wherein the gasification inlet is configured to add gases into the vapor space above the fluidized bed at a plurality of levels and in accordance with a plurality of sensors; and
a processed fuel over bed tube configured to redeposit processed carbon, reinject other materials into the fluidized bed and vapor space, or both.

3. The apparatus of claim 2, wherein gases are added into the vapor space at a plurality of distinct levels defined by elevation above an active fluidized bed, wherein the plurality of sensors is configured to control residence time and an amount and concentration of gases to optimize formation and height of vapor clouds formed in an upper vapor space of the system wall height.

4. The apparatus of claim 3, wherein the levels are configured to activate the biochar.

5. The apparatus of claim 1, wherein the products comprise: thermal energy, chemicals from gas stream, liquid fuel, char, carbon products, micro-particles, nano-particles, ash products, or combinations thereof.

6. The apparatus of claim 2, further comprising:
a cyclone coupled to the gasification section and a bag house configured to collect products exiting the vapor space;
a sonicator attached to the cyclone, wherein the sonicator is configured to remove ash, char, and carbon from the system wall;
a plurality of inlets designed for injection and extraction of Low BTU Gas (LBG) or other gas chemicals, wherein the LBG or the other gas chemicals are injected into or extracted from the cyclone at select locations to produce the products;
an electromagnetic particle removal passage for removing magnetic or iron particles from the cyclone;
an ash and carbon sorting and removal passage configured to sort and remove ash and carbon from the cyclone, wherein the ash and carbon art sorted and removed at select locations to produce a plurality of the products, and wherein a composition, size, and structure of each of the plurality of products correspond to its respective location; and
a drying system configured to dry the products, biomass feedstocks, or both.

7. The apparatus of claim 6, further comprising a boiler and a carbon and LBG burner.

8. The apparatus of claim 6, further comprising an ash and carbon particle separator, inlets and outlets and a plurality of filters, wherein the ash and carbon particle separator is coupled to a plurality of reaction chambers, and wherein the plurality of filters separates char particles based on size.

9. The apparatus of claim 8, wherein char is reacted with 3% hydrogen peroxide and extracted by pressurized flow through the plurality of filters.

10. The apparatus of claim 6, wherein the ash and carbon particle separator is configured to separate large particles using gravitational flow, and nano-particles using charge/discharge, sonication, or both.

11. The apparatus of claim 7, wherein a discharge, from the gasification chamber, the cyclone, or the LBG burner, comprises an Exhaust Gas Recirculation (EGR) fan, and wherein the EGR fan recirculates LBG or at least a product of the combustion to either the fluidized bed air inlet, or the gasification inlet.

12. A method comprising:
inputting moisture, gas, chemicals, or combinations thereof, to a gasification chamber or a fuel bin;
adjusting a plurality of conditions comprising temperature, time, and feedback composition;
changing a chemical composition or ratio of a bed material;
extracting char or carbon from a bed level;
extracting flying char material by an electromagnetic particle removal passage;
extracting flying char or carbon by a bag house; and
separating char from ash.

13. The method of claim 12, further comprising:
adding the bed material into a bed through a port above the bed prior to and periodically during feeding in of biomass material, wherein the bed material comprises iron oxide particles, metals, or combinations thereof;
adding the biomass material to the fuel bin, wherein an amount of dirt and a ratio of moisture of the biomass material are computed, the computed amount of dirt and ratio of moisture are used to adjust the plurality of conditions;
metering a fuel into the bed, wherein the fuel is gasified in the bed and further gasified in the gasification chamber to fine tune properties of a product, wherein the properties include porosity, and wherein the temperature is maintained at 800 to 2,200° F.;
forming biochar magnetic particles through oxidation of the iron oxide particles on the face of biochar, wherein the biochar magnetic particles are air classified by a size exiting the gasification chamber defined by a system wall height;
capturing the biochar magnetic particles at a bed height through a weir or after the biochar magnetic particles exit the gasification chamber and a cyclone, wherein micro and nano-particles are collected on charged metal ribbons of the bag house and larger particles are removed by gravity flow and wherein nano-particles are removed from the metal ribbons through charge/discharge, by sonication, or combinations of both;
activating the biochar magnetic particles based on the feedstocks for fuel or the composition of the bed material; and
separating magnetic biochar by size classification by pressurized flow through a series of filters for collection of the biochar magnetic particles of difference size.

14. The method of claim 13, wherein the temperature is maintained at 1,600° F.

15. The method of claim 12,
adding the bed material into a bed through a port above the bed prior to and during feeding in of biomass material, wherein the bed material comprises metals;
adding the biomass material to the fuel bin, wherein an amount of dirt and a ratio of moisture of the biomass material are computed, the computed amount of dirt and ratio of moisture are used to adjust the plurality of conditions;
metering a fuel into the bed, wherein the fuel is gasified in the bed and further gasified in the gasification chamber to fine tune properties of a product, wherein the properties include porosity, and wherein the temperature is maintained at 800 to 2,200° F.;
forming biochar particles, wherein the biochar particles are air classified by a size exiting the gasification chamber defined by a system wall height;
capturing the biochar particles at a bed height through a weir or after the biochar particles exit the gasification chamber and a cyclone, wherein micro and nano-particles are collected on charged metal ribbons of the bag house and larger particles are removed by gravity flow and wherein nano-particles are removed from the metal ribbons through charge/discharge, by sonic horn vibration;
activating the biochar particles based on the feedstocks for fuel or the composition of the bed material; and
separating the biochar further by size classification by pressurized flow through a series of filters for collection of the biochar particles of difference size.

16. The method of claim 15, wherein the temperature is maintained at 840° F. to 2,000° F.
